(19) United States
(12) Patent Application Publication
(10) Pub. No.: US 2009/0014279 A1
(43) Pub. Date: Jan. 15, 2009

(54) METHOD AND DEVICE FOR AUTOMATING A CHAIN FOR DISTRIBUTING MEAL TRAYS

(75) Inventor: Joel Bouetard, Castres (FR)

Correspondence Address: YOUNG & THOMPSON, 209 Madison Street, Suite 500, ALEXANDRIA, VA, 22314, US

(73) Assignee: SOCITE D'EXPLOITATION HOPI CAAP (SEHC) SARL, CASTRES (FR)

(21) Appl. No.: 12/090,872

(22) PCT Filed: Oct. 20, 2006
(86) PCT No.: PCT/EP2006/067617

§ 371 Date: Sep. 15, 2008

(30) Foreign Application Priority Data
Oct. 20, 2005 (FR) 0510722

(51) Int. Cl. B65G 43/08; B65G 47/50; G05B 19/00

(52) U.S. Cl. 198/358; 700/226; 198/340

(57) ABSTRACT

A device for automating a chain for distributing meal trays includes a plurality of trays (11) each of which is provided with identification elements, a plurality of carriages (200), a tray conveying chain (150) used for providing the trays with meal components and a computer system for assigning the trays to carriages in such a way that each tray is transported to the destination thereof by the carriage. In a preferred embodiment, the computer system is designed in such a way that it makes it possible to select the tray contents of a sequence of trays addressed to the same recipient service. In the preferred embodiment, each tray identification elements is provided with an electronic label, for example a RFID label, a radiofrequency identification or a rewritable memory.

### TECHNICAL FIELD

This invention relates to a process and a device for automating a line for distributing meal trays and recovering small containers. It applies in particular to the distribution of group meals, of institutional catering, more particularly in a hospital setting.

Meal tray is defined as any type of container that can accommodate one or more meals.

### PRIOR ART

The organization of meal tray assembly lines is based on a tray conveyor belt, in relation to technical machine groups that ensure the deposition of components of the meal. Each machine group requires the presence of at least one stationed operator. For example, for the structures of medium size, a tray assembly line consists of the following stations:

a tray-deposition station,

a “vegetable” station,

a “meat” station,

an “hors d'oeuvres” station,

a dessert station, and

a loading station.

Thus, seven operators can be mobilized between one and two hours, twice per day, which represents a significant financial cost for the structure. In addition, numerous mistakes or oversights occur and represent an additional cost and workload, an annoyance for the recipient of the tray and disregard of the components of the meals linked to pathologies. In addition, the allotment of the meals for the units in multi-portions (a small container may contain several portions for several patients) adds additional costs and workloads.

A unit for preparation of meal trays for patients of a hospital is known from U.S. Pat. No. 4,323,110 (RUBBRIGHT). The trays are prepared by hand.

### DISCLOSURE OF THE INVENTION

This invention aims at eliminating these drawbacks by the use of modules ensuring the automated operation of one or more stations.

For this purpose, this invention aims at, according to a first aspect, a device for automating a meal tray distribution line, characterized in that it comprises:

a number of trays, each equipped with a means of identification,

a number of carts,

a line for conveying trays that is designed to fill trays with meal components, and

a computer system that is designed to assign the trays to the carts so that each tray is transported, in a cart, to its recipient.

According to particular characteristics, the computer system is designed to fill carts by reducing the number of destinations of each cart.

According to particular characteristics, the computer system is designed to select the contents of trays so that a series of trays is intended for the same section to which it is bound.

According to particular characteristics, the means for identifying trays each comprise an electronic label.

According to particular characteristics, each electronic label comprises a rewritable memory.

Owing to each of these arrangements, the trays can be identified remotely and assigned to recipients.

According to particular characteristics, the computer system is designed to assign each tray to a recipient and each recipient to a list of components to be put on the tray.

According to particular characteristics, the computer system is designed to assign a patient card that identifies in particular the first and last names of the patient, his room, his bed, his diet and/or the menu that is selected for each of the trays.

According to particular characteristics, the conveyor line comprises at least one reader of identification means of the trays in communication with at least one automatic device.

According to particular characteristics, the conveyor line is equipped with automatic devices for distributing components on the trays and with means for detecting when each tray arrives with regard to said automatic devices, whereby the distribution of the components is synchronized based on when the trays arrive with regard to the automatic device.

According to particular characteristics, the conveyor line is equipped with at least one recovery station comprising a display screen, and the computer system is designed to display, for at least a portion of the trays, at least one component identifier to be placed on the next tray that arrives at said recovery station.

According to particular characteristics, the device as succinctly disclosed above comprises communication terminals with tray transport carts, and the computer system is designed to transmit to said carts data that are representative of their loads.

According to particular characteristics, each cart is designed to bring the products of trays back to a temperature based on data that are representative of the load thereof.

According to particular characteristics, the automatic device as succinctly disclosed above comprises a means for automatically loading the carts.

According to particular characteristics, the device as succinctly disclosed above comprises a means for changing the cart that is designed, when a cart is filled, to install an empty cart.

According to particular characteristics, the device as succinctly disclosed above comprises a means for memorization of each tray in each cart.

According to particular characteristics, the computer system is designed to recover a tray on a cart in the event of a change affecting the patient.

According to particular characteristics, the device as succinctly disclosed above comprises a means for recovering small containers and a means for washing recovered small containers.

### BRIEF DESCRIPTION OF THE DRAWINGS

Other advantages, objects and characteristics of this invention will emerge from the following description, done with an explanatory but in no way limiting object with regard to the accompanying drawings, in which:

FIG. 1 shows, diagrammatically, in top view, a particular embodiment of a meal tray assembly line according to this invention,

FIG. 2 shows, diagrammatically, in cutaway view, an automatic device for depositing a small container that can be incorporated in the meal tray assembly line that is illustrated in FIG. 1,

FIG. 3 shows, diagrammatically, in cutaway view, an automatic device for depositing round fruits or prepackaged products that can be incorporated in the meal tray assembly line that is illustrated in FIG. 1,

FIG. 4 shows, diagrammatically, in cutaway view, a station for loading the cart from a meal tray assembly line,

FIG. 5 shows, diagrammatically, in top view, the station for loading the cart from a meal tray assembly line that is illustrated in FIG. 4,

FIG. 6 shows, diagrammatically, in top view, an additional module for recovery of material.

### BETTER EMBODIMENT OF THE INVENTION

As shown, the device for automating distribution line 100 of meal trays 115 comprises a number of trays 115 that are each equipped with an identification means, a conveyor line 150 of trays that is designed to fill the trays with meal components, a number of carts 200 for transport of the filled meal trays to their recipients, and a computer system that is designed to assign the trays to the carts so that each tray is transported, in a cart, to its recipient.

The conveyor line 150, without this being limitative, can comprise a linear conveyor with an endless element for receiving trays, held between a driven roller and a driving roller driven by an electric motor element that may be any stepper-type motor. The endless element may be constituted by an endless belt, by a number of endless drive belts placed in parallel by tension between the driving roller and the driven roller. This conveyor is designed for the transport of trays from a zone for loading empty trays to be filled to a zone for unloading filled trays. Along this conveyor, the line will be equipped with stations for filling trays that each consists of one or more automatic devices for distributing components 145 for filling trays, whereby these components are food products but can also be place settings and napkins that are disposable, drinking cups and other utensils that are necessary for eating the meal.

Each tray 115 is equipped with a means of identification, for example an electronic label, for example of the RFID type (acronym for RadioFrequency IDentification), placed on, made integral with, buried or embedded in the tray. Each tray 115 can thus be identified by electronic label readers of the known type. As a variant, the tray card is equipped with identification means, for example a radiofrequency electronic label that optionally comprises a rewritable memory; it is then the electronic label of the tray card that is read and makes it possible for the tray 115 to be identified.

According to a variant embodiment, the conveyor that the conveyor line comprises is provided with dedicated positions for receiving trays, and the means for identifying the trays 115 can consist of electronic labels that are integrated into the positions that are dedicated to receiving the trays. It goes without saying that any other element for identification can be used. The electronic labels can each comprise a rewritable memory. In this case depicted, the trays can also comprise an identification means that can be of the type of the one that is described above or more simply consists of a printed ticket that comprises inscriptions necessary for the identification and the tray and the recipient patient.

Once filled, the trays are packed in the carts 200.

Each cart 200 is identified, for example, by an electronic label or by means of a rewritable memory, for example remote, by a terminal with Hertzian communication (for example WIFI or Bluetooth), whereby the necessary electronic means, well known to one skilled in the art, are not presented in detail here. In the latter case, a central computer system is designed to write data for identification and/or transfer in the rewritable memory of the cart 200. A display system that is integrated in the cart allows the display of these data.

The positioning of the trays 115 in the cart 200 is derived by the computer system using a formatted logic based on the rooms of the section and distribution in the halls. The orders of positioning are therefore constructed at the beginning of the distribution of trays and taking into consideration the logic of filling the carts.

This formatting makes it possible to have only one control that is loaded on the loading device 195: the reading of the data relative to the positioning (level of the cart) and to their monitoring with the orders provided by the computer system.

Each level, or stage, of the cart 200 is equipped with a readable mark, for example with an electronic label, which assigns a heating plate or cell for bringing the product of a tray 115 to a temperature, a tray that is itself assigned to a dish so as to make it possible to optimize the program for bringing the product back to a temperature before distribution. The tracking of a tray 115 in a cart 200, including the level where it is found in the cart, also makes possible the recovery of a cart 200 then of a tray 115, and then the reloading of another tray 115 in the cart 200 in the event of the reassignment of a patient or of a diet to a patient.

The centralized computer system ensures the following functions:

The management of the file of the patients and the requests,

The assignment of a patient card (which identifies in particular the first and last names of the patient, his room, his bed, his diet, the menu selected), and his request for a tray, the selection of the cart 200,

The tracking of the tray 115 on the tray assembly line 100,

The management of the loaders of meal components of the automatic devices of the conveyor line 150 and their products,

The control of the automatic devices 120, 125, 135, and 140 for distribution of the meal components,

The management of the trays 115 on the recovery circuit 130,

The display of the requirements of the tray by loading on a recovery station 30, i.e., a non-automated position,

The tracking of each cart 200 above a centering point 205 and the order for transfer to the transfer device 210 (known under the name of “tortoise” or “tal,” acronym for heavy automated transport),

The management of loading levels of each cart 200 and their assignment to the identifier of the corresponding trays 115,

The transfer, by means of a Hertzian communication terminal, of data, for example loading information for optimizing the cycle for bringing the product back to a temperature (for example, if a patient is undergoing an examination, the heating of the dishes of his tray can be delayed),

The recovery of cart 200, tray 115 and small containers 145 for washing the small containers 145 and recovery of each small container 145 or the material of which it is made, for example polypropylene.

During the detection of the absence of an electronic label on a cart 105 for loading the trays, it is expected that there are no more trays on this cart 105 and the automatic devices 120, 125, 135 and 140 of the conveyor line 150 of the trays 115 are put in standby mode. Conversely, the presentation of a cart 105 that is loaded with trays 115, linked to a validation of resumption of operation, restarts the automatic devices 120, 125, 135 and 140.

At the input of the conveyor line 150, an automatic device 110, for example with suction-cups, ensures the setting of a tray 115 into a stack of trays of a constant-level cart 105 and the deposition of the tray 115 on the conveyor line 150.

Preferably, the conveyor line 150 will be equipped with a dedicated computer that is part of the computer system of the device. This computer that consists of, for example, a microcomputer and suitable software will be able to be programmed with compositions of the meal trays that are to be prepared.

So that the trays 115 follow good alignment on the conveyor line 150, a centering by double lateral flushing (two arms, for example pneumatic arms, come to grip the tray laterally and align it on the conveyor) is provided at the input of the conveyor line 150. For example, a double slide that is calibrated to the format of the tray (preferably its width) aligns its edges to the edges of the conveyor line 150.

Thus, two micro-centering tools that are perpendicular to the conveyor line and to the plane of the trays push the tray toward the center of the conveyor, under the control of an automatic device that is slaved to the automatic device for depositing the trays 110 or to the tracking of the arrival of the tray, for example by an optical detection cell, mechanical cell or from reading the electronic label 107. In the latter, preferred case, a reader of electronic labels 107 that is placed close to the input of the conveyor line 150, for example below, verifies that the electronic label of the tray is readable. If it is not readable, the conveyor line 150 is stopped, and an alarm is triggered so that the defective tray 115 is withdrawn.

The identification of the tray is transmitted by this reader 107 to the computer system. The computer system assigns this identification to a patient card and immediately generates a series of orders or requests, in particular intended for the automatic devices 120, 125, 135 and 140 of the conveyor line 150, whereby the triggering of the required actions is contingent upon the detection of the tray 115 in question with regard to the automatic devices 120, 125, 135 and 140 on the conveyor line 150. These requests are kept by the automatic devices in question. The management of the assignments can also be ensured as movement of the tray 115 by the computer system proceeds. In this case, the detection of a tray 115 on a reading terminal of the conveyor line 150, itself assigned to at least one automatic device upstream from the automatic device, triggers another request intended for the automatic device in question.

At the station following the automatic device 110, an automatic device prints and places on the tray a tray card that describes, in text form, the components for the meal corresponding to the tray. This tray card is used as a check in the event of an anomaly in the system, for monitoring during the distribution of trays in the sections and for informing the patient of the composition of his meal. As indicated above, as a variant, this tray card comprises an electronic label that comprises a rewritable memory. Each electronic label receives and then preserves data relating to the components of the meal that should be placed on the tray 115 that is assigned to it. In this case, the content of the tray card brings about, at the time of its reading by a reading terminal, upstream from at least one automatic device, the operation of this automatic device.

At the stations following the automatic devices for placing tray cards, automatic devices 120, 125, 135 and 140 place the small containers 145 of meat and vegetables or any other component of the meal. These automatic devices 120, 125, 135, and 140 are, for example, rotary devices with loaders, in-line automatic devices or automatic devices that are perpendicular to the conveyor line, equipped with a transfer line. In each of their loaders, they keep several small containers that contain the same component, whereby the computer system automatically manages the loaders that are identified and assigned to the meal components that they contain.

Preferably, an electronic label reader provides the identification of the tray to the automatic device, and the latter validates the correspondence between the content of the small container 145 to be placed and the tray 115 in question, before placing the small container 145 on the tray 115, so as to prevent the risks of assignment error, in particular in the case of heavy dietetic meals. As a variant, the information that relates to the reference of the tray 115 is provided to the computer system that then triggers a request intended for the automatic device 120, 125, 135 or 140, according to the detection site, on the conveyor line 150. As a variant, in the case where the electronic labels of the trays comprise a rewritable memory, the content of the rewritable memory triggers the request intended for the automatic device in question so that the latter selects and places the small container in question.

As a variant, a bar code reader reads a bar code label on the small container 145 to be placed on the tray 115, and the automatic device validates the correspondence between the content of the small container 145 and the tray 115 in question, before placing the small container 145 on the tray 115, so as to avoid risks of assignment error. This variant provides a second level of monitoring and safety.

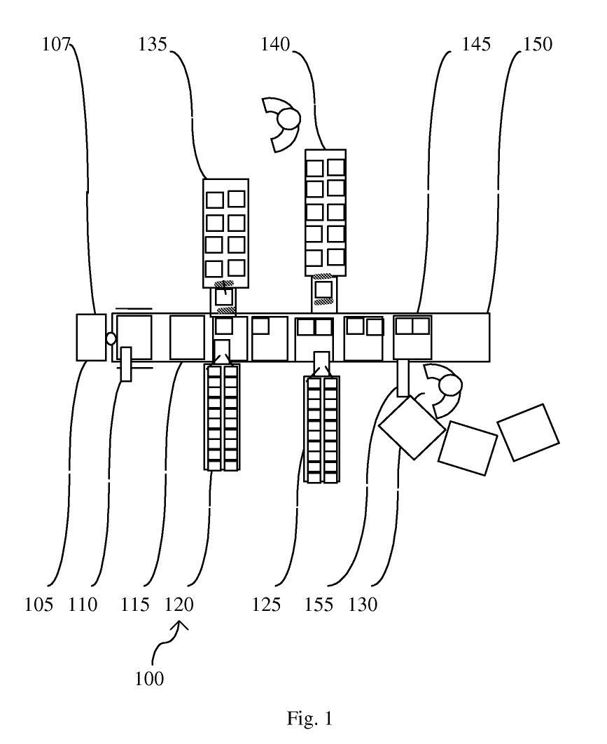

The perpendicular automatic devices 120, 125, 135 and 140 that are illustrated in FIG. 1 offer the advantageous of a significant modularity, the possibility to integrate as many loaders as necessary and to integrate known means.

These automatic devices 120, 125, 135 and 140 each combine one translation line per family of product and a set of stationary and linear loaders. Using the requests transmitted by the computer system or generated from the contents of rewritable memories of electronic labels assigned to trays 115, the depositing sequences of the products are programmed by the automatic devices 120, 125, 135 and 140. Based on the size of the conveyor line 150 and the number of loaders, a number of six programmable sequences is typical. In the embodiment that is shown in FIG. 1, the automatic devices 120, 125, 135 and 140 track the request for a meal tray 115, three trays before the placing of the tray, and deposit the small container in question on the first wide belt designed to cover all of the loaders, i.e., to run the two lines of loaders that are on both sides of the conveyor line, two trays before the placing. Centering tools then position the small container at the input of the translation belt that is sized to the standardized width of the small containers, and the small container there is put on standby for transfer to the meal tray of the preceding small container. One tray before the placing, the small container 145 is released and is locked on the translation belt until the meal tray 115, which corresponds to it, arrives with regard to the output of the translation belt (the detection of this tray is preferably carried out by an electronic label reader). It is observed that the positioning of the output of these translation belts ensures that the small container is placed in the zone of the meal tray that is dedicated to it, whereby the belt can be a projection belt, i.e., can bring the meal element above the tray 115 to place it in the center or on the other side of the tray 115.

Whereby the loaders of the automatic devices 120, 125, 135, and 140 are static, the supplying during the operation is simplified.

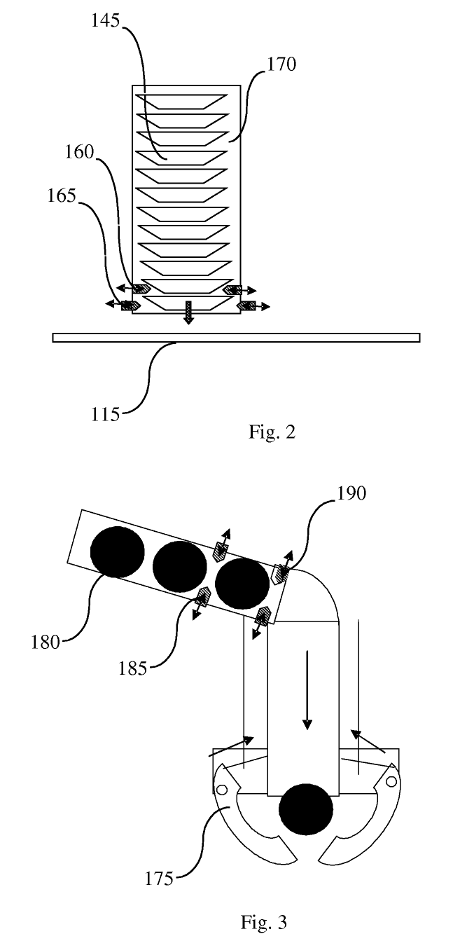

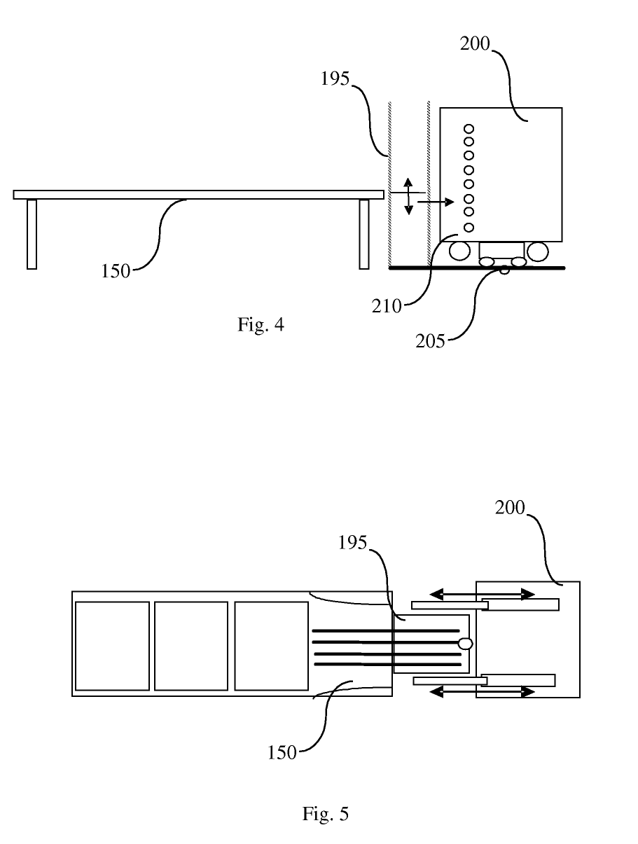

As observed in FIG. 2, an automatic device for placing small containers can also consist of a vertical tank 170 that is equipped with two sets of clips 160 and 165 that are able to block the vertical movement of the small containers 145 under the effect of their weight. The distribution is then carried out as follows. In a first step, the upper clips 160 and lower clips 165 are closed, and lock, respectively, a column of small containers 145 and a small container 145. In a second step, the lower clips 165 are opened and release the lower small container 145 on the meal tray 115 that is found opposite the automatic device. In a third step, the lower clips 165 are reclosed. In a fourth step, the upper clips 160 are opened, and the column of small containers 145 goes down from the thickness of a small container 145 until the lower small container is resting on the lower clips 165. Then, the upper clips 160 are reclosed, and a return is made to the first step.

FIG. 3 shows, diagrammatically, in cutaway view, an automatic device for placing round fruits 180 or pre-packaged products that can be incorporated in the meal tray assembly line that is illustrated in FIG. 1. The upper clips 185 and lower clips 190 are controlled in the same manner as disclosed above with regard to FIG. 2. The opening of an end clip 175 is controlled when a tray 115 arrives in the proper position.

A detection cell that is placed between the upper clips 160 and the lower clips 165 signals the absence of a small container 145 and if a relay loader has been provided, an order to start unloading is transmitted to it.

At the following stations, the automatic devices 135 and 140 for distributing hors d'oeuvres, milky desserts, pre-packaged products and/or fruits operate in the same manner as the automatic devices 120 and 125 for distribution of small containers of meat or vegetables.

According to a variant embodiment, each automatic device for distributing components 145 comprises, on the one hand, a storage unit, for example in the form of a vertical turret that is driven in rotation around a vertical axis, whereby this vertical turret comprises one or more stages for storing components 145, which are identified by a code affixed to their packaging and, on the other hand, a motorized multi-axis manipulating arm that is equipped with a reader that can read codes for identifying components and an end gripper, whereby with the gripper that it comprises, said manipulating arm is able to grip one of the components in the assigned storage unit and to place said component on the tray that is carried by the conveyor line. The reader can be a camera or another system.

If necessary, the conveyor line 150 comprises at least one recovery station 130, i.e., non-automated stations in which an agent carries out the placing of meal components on the trays 115. Each recovery station 130 is provided with a screen 155 whose display is controlled by the computer system and indicates the component or components to be placed manually in the next tray 115 to come. As an option, a bar code reader makes it possible to verify compliance with the displayed instructions.

The computer system controls the assembly of the trays 115 section by section, so as to make possible the loading of carts 200 so that each of the carts 200 corresponds to a minimum of various sections. Each time that the loading of a cart 200 has to be interrupted, manually or automatically, the computer system provides information allowing this loading interruption. For example, in the event of a manual loading, it is necessary to stop the conveyor line 150 and to light up a light that requests that an empty cart be positioned at the output of the conveyor line 150, whereby the restarting is carried out after validation by the operator.

Optionally, an output station provides destination data to the cart, identifying the trays intended for each section to which it is bound of the cart 200, for example, in the form of a printed sheet that is placed on the loaded cart 200 by the operator or automatically or in the form of a registration in a rewritable memory of the cart 200.

In the case where the loading of the carts 200 is automatic, the computer system controls the loading of each cart 200 and assigns the destination data to the loaded cart 200, as described above.

The management of carts 200 is preferably automated. For this purpose, empty carts 200 are kept in a specific dedicated space, called “storage of empty carts,” and the carts 200 that are loaded with trays are also kept in a specific dedicated space, called “cart departure station,” before they are transported to the sections.

The conveyor line 150 is preferably located between these two spaces. Each of the carts 200 is in communication in order to receive data or requests from the computer system. The carts 200 are equipped with a display, for example, a liquid crystal screen, to display the section to which it is bound, information provided by the computer system. Preferably, the carts 200 are also equipped with a rewritable memory for recording and providing, depending on the section to which it is bound, the transport coordinates, so that transport devices 210 carry out the transport of the cart to the section to which it is bound. In this variant, this memory also records the characteristics of bringing the products of the trays to a temperature based on dishes and/or delay of transport to their recipient.

Each of the carts 200 provides to the computer system data relating to the hot line and the cold line and any problems noted.

Preferably, each level of the cart 200 is identified electronically and assigned to the tray 115 that it supports, during its loading, whereby the computer system receives these data for determining the instructions for bring the products of the trays 115 to a temperature and for transmitting them to the cart 200 in question.

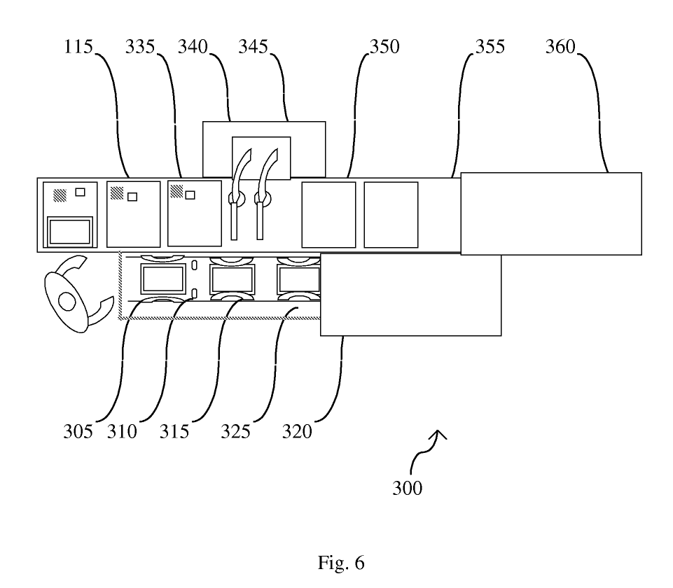

As far as the recovery of the material of the body of the small container is concerned, as a variant, an automatic module 300 for sorting and washing small containers, illustrated in FIG. 6, is provided to recover this material. It is recalled that the small container 145 consists of two elements, the unrecoverable film and the recoverable small container body, for example, made of polypropylene. In this additional module 300, the cart 200 is emptied onto a conveyor element 355, the small containers 335 are held by clips or suction means, they are returned for emptying the contents into a trash can, their cleaning is carried out with water, the contaminated water is passed through a centrifuge to recover the solid waste, the small containers are cleaned with detergent, the small containers are passed into an oven for sterilizing them, they are dried in hot air, and the small containers are removed.

For this additional module, the system is based on:

1. An automation of the recovery of trays 115 in the carts 200 for meal distribution;

2. A semi-automatic recovery of small containers 145;

3. The treatment of stain removal, washing, drying, cutting and automatic packaging of small containers;

4. An automatic stain removal (technical term designating the removal of residual wastes from a napkin or a tray) of the tray, and

5. The treatment of washing and disinfecting the tray as well as its automatic recovery.

As far as the automation of the recovery of trays is concerned, its principle is based on a piece of equipment that is identical to the loading module of carts, whereby the handling of carts can be treated manually or by means of tortoises and a transport device.

A system for detection, for example optical detection, of the presence of trays on the tracks of the cart initiates the procedure for recovering the tray that is placed on a bi-cord transfer belt. The flushing of the tracks of the cart is incremented in the unloading device that controls the rotation of the cart to treat, if necessary, the other compartment. After having been emptied, the cart is directed manually or automatically to a tunnel for washing the carts.

As far as the semi-automatic recovery of the small containers is concerned, it is recalled that the polypropylene, comprising disposable bodies of small containers, is a raw material whose cost is changing all the time. This product can be recovered in two forms: in recycling after remelting or in the form of fuel.

The advantage of the recovery resides in the implementation of an HQE (acronym of High Quality Environmental, meaning that there is a low consumption of water and detergent products) recovery principle and with a reduced personnel requirement.

The principle is based in a first step on a human operation that consists in:

Separating the film (protective cap) from the small container, whereby the film cannot be recovered,

placing the small container on the washing rail.

The stain removal operations are treated automatically. The rate of six trays per minute (or twelve small containers) is maintained for a manual operation, and this rate can be increased by the addition of a second station for recovery and a multi-track washing machine.

As far as the automatic treatment of small containers and the recovery of polypropylene, during a first stage, are concerned, the small containers are placed by the operator and returned to a translation rail. During a second stage, during the progress of the small containers, a mechanism engages a double clip that holds the small container by the flange, thus allowing a pressure-washing at a later stage.

The translation rail moves the clamped container forward with the aid of a box unit whose characteristics are as follows:

Box 1—Stain removal from small containers by a pressurized water jet in emulsion with the compressed air or stain removal from the small container by high-pressure water jet, the water is recovered, the solid materials are recovered by centrifuging, the water is recycled, at the end of the cycle, and the water is evacuated after disinfection.

Box 2—Disinfection and degreasing of the small container by adding a product that is suitable in water, the water is filtered and recovered in a closed circuit; only a portion of the water is recovered and transferred into the box 1.

Box 3—Oven-drying and disinfection of the small container by high-pressure vapor injection.

Box 4—Drying by a hot air turbine.

The material of the boxes 2 and 4 is known in the washing tunnels.

At the output of the box 4, the small containers are dry. They are then engaged in a rolling machine. At this stage, the locking clips of the small containers are released to crush the product; a principle of lateral and horizontal cutaways slices up the polypropylene. The clean and crumbled polypropylene is recovered in storage containers and, if necessary, optionally pressed to reduce its volume.

In contrast, as far as the automatic stain removal of the tray is concerned, the translation belt advances the trays at a variable rate of six trays per minute. Two projection arms that are equipped with a suction cup project the tray and allow a stain removal of the residual reliefs above a container. A short-handled brush can supplement this automatic device to ensure a better cleaning. The tray is then engaged in a tray washer of the known type and recovered at the end of the cleaning on a constant-level cart.

This additional module allows the recovery of a cumbersome raw material while optimizing a set of necessary functions that are the recovery, the sorting and the washing of trays in a hospital setting. A recovery of 80% of the containers can be expected in unified hospital structures or at the satellite sites.

In FIG. 6, in a top view, a diagram of the line 300 for stain removal and for recovery of small containers is observed. A clip with small containers 305 in raised position, a lug 310 for closing the clips, automatically actuating the closing of the clips during the progress of the small container, an identical lug releasing the small container during its engagement in the rolling mill, a clip 315 with small containers in closed position, a tunnel 320 for washing to the format of the small containers, a translation rail 325 of the mechanism for placing and clamping small containers, a tray 115 on a bi-cord translation belt 355, residues 335 on the tray, a tray 350 from which stains have been removed, a container 345 for waste recovery, and a tray 340 that is projected by arms with suction cups are shown in this FIG. 6, whereby the stain removal is carried out by gravity and can be supplemented by an automatic flushing and a tunnel for washing trays 360.

The preparation of individual meal trays was described above, but it goes without saying that this invention also relates to the preparation of multi-portion meal trays, i.e., for several individuals. In this case depicted, it goes without saying that the robots and the technicians will agree to the multi-portion format.

Likewise, the production of meal trays for the patients of a hospital or other care centers has been described above, but it goes without saying that this invention also relates to the production of meal trays for school cafeterias and academic dining halls, etc.

1. Device for automating a distribution line (100) for meal trays (115), characterized in that it comprises:
a number of trays (115), each equipped with a means of identification,
a number of carts (200),
a line for conveying (150) trays that is designed to fill trays with meal components, and
a computer system that is designed to assign the trays to the carts so that each tray is transported, in a cart, to its recipient.

2. Device according to claim 1, wherein the computer system is designed to fill carts (200) by reducing the number of destinations of each cart.

3. Device according to claim 1, wherein the computer system is designed to select the contents (145) of the trays (115) so that a series of trays is intended for the same section to which it is bound.

4. Device according to claim 1, wherein the means of identification of the trays (115) each comprise an electronic label.

5. Device according to claim 4, wherein each electronic label comprises a rewritable memory.

6. Device according to claim 1, wherein the conveyor line comprises a conveyor that is provided with dedicated positions for receiving trays, and wherein the means for identifying the trays (115) are integrated into the positions dedicated to receiving the trays.

7. Device according to claim 6, wherein the means of identification consist of electronic labels.

8. Device according to claim 7, wherein the electronic labels each comprise a rewritable memory.

9. Device according to claim 1, wherein the computer system is designed to assign each tray (115) to a recipient and each recipient to a list of components (145) to put on the tray.

10. Device according to claim 1, wherein the computer system is designed to assign a patient card, which identifies in particular the first and last names of the patient, his room, his bed, his diet and/or the menu that is selected for each of the trays.

11. Device according to claim 1, wherein the conveyor line (150) comprises at least one reader (107) of means of identification of the trays (115).

12. Device according to claim 1, wherein the conveyor line (150) is equipped with automatic devices (120, 125, 135, 140) for distributing components (145) on the trays (115) and with means for detecting when each tray arrives with regard to said automatic devices, whereby the distribution of the components is synchronized based on when the trays arrive with regard to the automatic device.

13. Device according to claim 12, wherein each automatic device for distributing components (145) comprises, on the one hand, a storage unit in the form of a vertical turret that is driven in rotation around a vertical axis, whereby this vertical turret comprises one or more stages of storing components (145), which are identified by a code affixed to their packaging and, on the other hand, a motorized multi-axis manipulating arm that is equipped with a reader that can read codes for identifying components and an end gripper, whereby with the gripper that it comprises, said manipulating arm is able to grip one of the components in the assigned storage unit and to place said component on the tray that is carried by the conveyor line.

14. Device according to claim 13, wherein each automatic device for distributing components (145) comprises a translation line per family of product and a set of stationary and linear loaders.

15. Device according to claim 1, wherein the conveyor line (150) is equipped with at least one recovery station (130) comprising a display screen (155), and the computer system is designed to display, for at least a portion of the trays, at least one component identifier to be placed on the next tray that arrives at said recovery station.

16. Device according to claim 1, wherein it comprises communication terminals with tray transport carts (200), and the computer system is designed to transmit to said carts data that are representative of their loads.

17. Device according to claim 1, wherein each cart (200) is designed to bring products of trays (115) back to a temperature based on data that are representative of the load thereof.

18. Device according to claim 1, wherein it comprises a means for automatic loading (195) of carts (200).

19. Device according to claim 1, wherein it comprises a suitable means (210) for changing the cart (200) that is designed—when a cart is filled—to install an empty cart.

20. Device according to claim 1, wherein it comprises a means for memorization of each tray (115) in each cart (200).

21. Device according to claim 1, wherein the computer system is designed to recover a tray (115) on a cart (200) in the event of a change to the assignment of the patient.

22. Device according to claim 1, wherein it comprises a means (300) for recovery of small containers (145) and for washing recovered small containers.
